(19) United States
(12) Patent Application Publication
(10) Pub. No.: US 2016/0148342 A1
(43) Pub. Date: May 26, 2016

(54) MOVEMENT OF DISPLAYED ELEMENT FROM ONE DISPLAY TO ANOTHER

(71) Applicant: LENOVO (SINGAPORE) PTE. LTD., New Tech Park (SG)

(72) Inventors: ROD DAVID WALTERMANN, Rougemont, NC (US); JOHN CARL MESE, Cary, NC (US); NATHAN J. PETERSON, Durham, NC (US); ARNOLD S. WEKSLER, Raleigh, NC (US); RUSSELL SPEIGHT VANBLON, Raleigh, NC (US)

(21) Appl. No.: 14/550,107

(22) Filed: Nov. 21, 2014

(51) Int. Cl. G06T 3/40; G06F 3/14

(52) U.S. Cl. CPC G06T 3/40; G06F 3/1431

(57) ABSTRACT

In one aspect, a device includes a processor, a first display accessible to the processor, and a memory accessible to the processor. The memory bears instructions executable by the processor to, in response to movement to the first display of a lateral segment of an element presented a second display, present a portion of the lateral segment on the first display at a first scaling factor and at the same height as the entirety of the lateral segment was presented on the second display. The instructions are also executable to identify a second scaling factor based on a difference in display characteristics between the first display and the second display, and in response to movement of at least a threshold amount of the element onto the first display, present at least the threshold amount of the element on the first display using the second scaling factor.

### FIELD

The present application relates generally to movement of a displayed element from one display to another display.

### BACKGROUND

When moving an element from one display to another display e.g. using a drag and drop action, the element can look distorted on the other display owing to differing display characteristics of the displays. This can be undesirable, confusing, and frustrating to the user.

### SUMMARY

Accordingly, in one aspect a device includes a processor, a first display accessible to the processor, and a memory accessible to the processor. The memory bears instructions executable by the processor to, in response to movement to the first display of a lateral segment of an element presented on a second display, present a portion of the lateral segment on the first display at a first scaling factor and at the same height as the entirety of the lateral segment was presented on the second display. The instructions are also executable to identify a second scaling factor based on a difference in display characteristics between the first display and the second display, and in response to movement of at least a threshold amount of the element onto the first display, present at least the threshold amount of the element on the first display using the second scaling factor.

In another aspect, a method includes in response to movement to is first display of at least one of a lateral segment of a window presented on a second display and a vertical segment of the window presented on the second display, presenting at least one respective portion of at least one of the lateral segment and the vertical segment on the first display at at least one of a first height matching a second height at which the entirety of the lateral segment was presented on the second display and a first width matching a second width at which the entirety of the vertical segment was presented on the second display. The method also includes identifying a scaling factor based on a difference in pixels per inch (PPI) between the first display and the second display and, in response to movement of the window entirely onto the first display, presenting the window on the first display using the sealing factor.

In still another aspect, a computer readable storage medium that is not a carrier wave includes instructions executable by a processor to identify a user as looking at a portion of a user interface (UI) presented on a first display, identify movement of the UI at least partially from the first display to a second display, present on the second display the portion of the UI looked, at by the user while the UI is moved from the first display to the second display, identify a scaling factor at which to present the UI on the second display, and in response to movement of the UI entirely to the second display, present the UI entirely on the second display using the scaling factor.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of a network of devices in accordance with present principles;

FIG. 3 is a flow chart showing an example algorithm in accordance with present principles; and

FIGS. 4A-6B are example illustrations of user interfaces (UIs) being moved between displays in accordance with present principles.

### DETAILED DESCRIPTION

This disclosure relates generally to device-based information. With respect to any computer systems discussed herein, a system may include server and client components, connected over a network such that data may be exchanged between the client and server components. The client components may include one or more computing devices including televisions (e.g. smart TVs, Internet-enabled TVs), computers such a desktops, laptops and tablet computers, so-called convertible devices (e.g. having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components. or any combination thereof designed to perform the functions described herein. A processor can be implemented by a controller or state machine or a combination of computing devices.

Any software and/or applications described by way of flow charts and/or user interlaces herein can include various sub-routines, procedures, etc. it is to be understood that logic divulged as being executed by e.g. a module can be redistributed to other software modules and/or combined together in a single module and or made available in a shareable library.

Logic when implemented in software, can be written in an appropriate language such as but not limited to C# or C++, and can be stored on or transmitted through a computer-readable storage medium (e.g., that ma not be a carrier wave) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and twisted pair wires. Such connections may include wireless communication connections including infrared and radio.

In an example, a processor can access information over its input lines from data storage, such as the computer readable storage medium, and/or the processor can access information wirelessly from an Interact server by activating a wireless transceiver to send and receive data. Data typically is converted from analog signals to digital by circuitry between the antenna and the registers of the processor when being received and from digital to analog when being transmitted. The processor then processes the data through is shift registers to output calculated, data on output lines, for presentation of the calculated data on the device.

Components included in one embodiment can be used in other embodiments in any appropriate combination. For example, any of the various components described, herein and/or depicted in the Figures may be combined, interchanged or excluded front other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

“A system having one or more of A, B, and C” (likewise “a system having one or more of A, B, or C” and “a system having one or more of A, B, C”) includes systems that have A alone, B alone, C alone, A and B together, A and C together, B and C together, and/or A, B, and C together, etc.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embedment as well as general-purpose or special-purpose processors programmed with instructions to perform those functions.

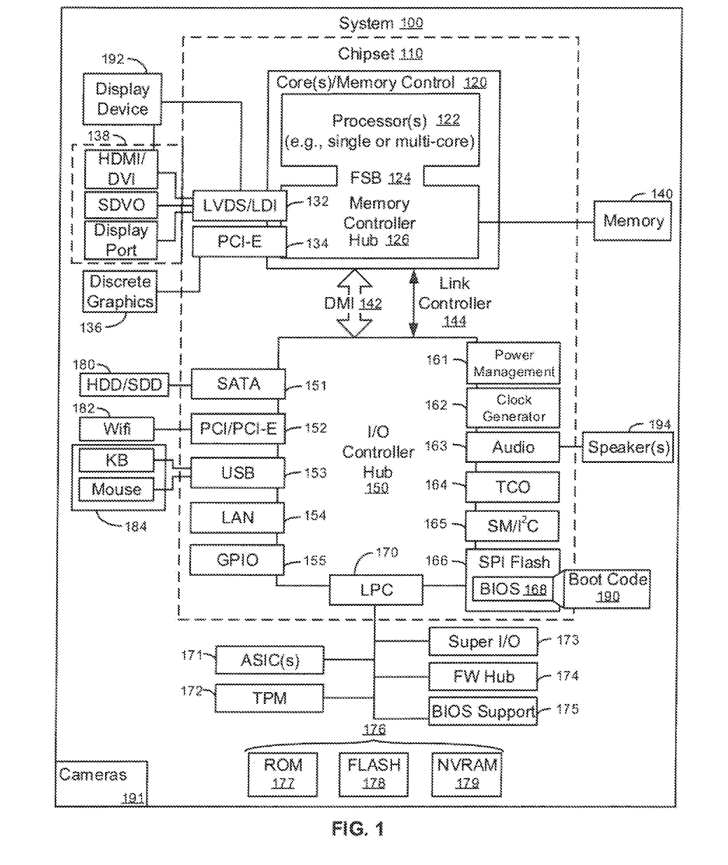

Now specifically in reference to FIG. 1, it shows an example block diagram of an information handling system and/or computer system 100. Note that in some embodiments the system 100 may be a desktop computer system, such as one of the ThinkCentre® or ThinkPad® series of personal computers sold, by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be e.g. a game console such as XBOX® or Playstation®.

As shown in FIG. 1, the system 100 includes a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the. chipset 110 includes a core and memory control group 120 and an I/O controller but 150 that exchange information (e.g., data, signals, commands, etc.) via, for example, a direct management interface or direct media interface (DMI) 142 or a link controller 144, in the example of FIG. 1, the DMI 142 is a chip-to-chip interface (sometimes referred to as being a link between a “northbridge” and a “southbridge”).

The core and memory control group 120 include one or more processors 122 single core or multi-core, etc.) and a memory controller hub 126 that exchange information via a front side bus (FSB) 124. As described herein, various components of the core and memory control group 120 may be integrated onto as single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 further includes a low-voltage differential signaling interface (LV DS) 132. The LVDS 132 may be a so-called LVDS Display Interface (LDI) for support of as display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port fur an external PCI-E-based graphics card (including e.g. one of more GPUs). An example system may include AGP or PCI-E for support of graphics.

The I/O hub controller 150 includes a variety of interfaces. The example of FIG. 1 includes a SATA interface 151, one or more PCI-E interfaces 152 (optionally one or more legacy PCI interfaces), one or more USB interfaces 153, a LAN interface 154 more generally a network interface for communication over at least one network such as the Internet, a WAN, a LAN, etc. under direction of the processor(s) 122), a general purpose I/O interface (GPIO) 155, a low-pin count (LPC) interface 170 a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and hoot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 provide for communication with various devices, networks, etc. For example, the SATA Interface 151 provides for reading, writing or reading and writing information on one or more drives 180 such as HDDs, SDDs or a combination thereof, but in any case the drives 180 are understood to be e.g. tangible computer readable storage mediums that may not be carrier waves. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.),

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing, platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

FIG. 1 also shows that the system 100 includes at least one and optionally plural cameras 191 for gathering one or more images and providing input related thereto to the processor 122. The cameras 191 may be, e.g., thermal imaging cameras, digital cameras such as webcams, and/or cameras integrated into the system 100 and controllable by the processor 122 to gather pictures/images and/or video such as of is user's face and eyes (and/or eye movement).

Additionally, though not shown for clarity, in some embodiments the system 100 may include a gyroscope for e.g. sensing and/or measuring the orientation of the system 100 and providing input related thereto to the processor 122, an accelerometer for e.g. sensing acceleration and/or movement of the system 100 and providing input related thereto to the processor 122, and/or an audio receiver/microphone providing input to the processor 122 e.g., based on a user providing audible input to the microphone. Still further, and also not shown for clarity, the system 100 may include a GPS transceiver that is configured to e.g. receive geographic position information from at least one satellite and provide the information to the processor 122. However, it is to be understood that another suitable position receiver other than a GPS receiver may be used in accordance: with present principles to e.g. determine the location of the system 100.

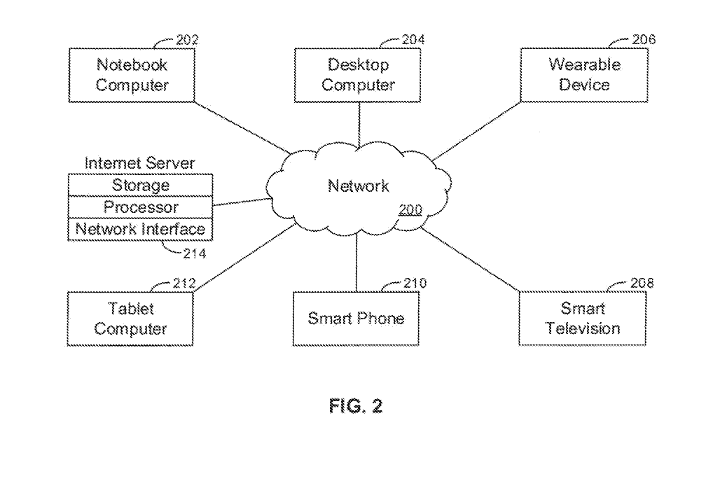

Before moving on to FIG. 2, it is to be understood that an example client device or other machine/computer may include fewer or more features than shown on the system 100 of FIG. 1. In any case, it is to be understood at least based on the foregoing that the system 100 is configured to undertake present principles.

Turning now to FIG. 2, it shows example devices communicating over a network 200 such as e.g. the Internet in accordance with present principles. It is to be understood that e.g. each of the devices described in reference to FIG. 2 may include at least some of the features, components, and/or elements of the system 100 described above. In any case. FIG. 2 shows a notebook computer 202, a desktop computer 204, a wearable device 206 such as e.g. a smart watch, is smart television (TV) 208, a smart phone 210, a tablet computer 212, and a server 214 in accordance with present principles such as e.g. an Internet server that may e.g. provide cloud storage accessible to the devices 202-212. It is to be understood that the devices 202-214 are configured to communicate with each other over the network 200 to undertake present principles.

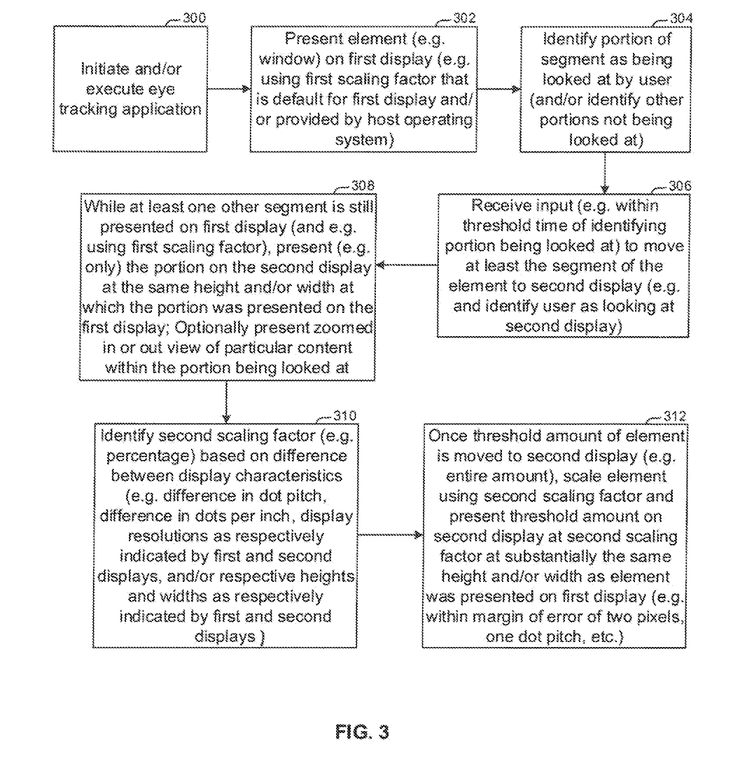

Referring to FIG. 3, it shows example logic that may be undertaken by a device such as the system 100 in accordance with present principles (referred to below as the “present device” for simplicity. Beginning at block 300, the logic initiates and/or executes an eye tracking application and/or software for undertaking present principles. The logic then proceeds to block 302 were the logic presents at least one element on a first display. The element may be e.g. a window (e.g. Internet browser window, word processor window, etc.), user interface (UI), icon widget, tile, photograph, audio video presentation, a file, etc. Note that in some embodiments, the element is presented at block 302 using a first scaling factor (e.g. a percentage) for presenting content on the first display that is e.g. a default sealing factor for the first display and/or as scaling factor provided by a host operating system (e.g. Microsoft Windows, Mac OS X, an Android-based operating system, etc.) running on the present device which communicates with the first display.

After block 302 the logic moves to block 304 where the logic identifies at least a portion of a segment of the element a lateral segment and/or a vertical segment) as being currently looked at (e.g. in real time) by a user using the eye tracking application initiated and/or executed at block 300. Also at block 304 and in some embodiments, the logic may identify other portions of the element that are not being looked at by the user. From block 304 the logic moves to block 306, at which the logic receives input (e.g. within a threshold time (e.g. established by a user based on input to the present device) of identifying the portion being looked at) to move at least the segment of the element comprising the portion to a second display different from the first display but also communicating with the present device to undertake present principles (e.g. presenting at least some of the element thereon under control of the present device's processor and/or a user command to move the element from presentation on the first display to presentation on the second display). Also at block 306 and in sonic embodiments, the logic may identify the user as looking at the second display after looking at the portion of the segment to e.g. determine that the user is providing input to move at least the portion of the segment of the element from the first display to the second display (e.g. using eye input to move the portion).

The logic of FIG. 3 then proceeds from block 306 to block 308. At block 308 the logic, e.g. while at least one other segment of the element is still presented on the first display, presents on the second display (e.g. still using the first scaling factor) the portion (e.g. a no other portions). The portion is presented on the second display at the same height and/or width as the portion was presented on the first display. Also at block 308, in sonic example embodiments the logic may present a zoomed in view (e.g. if the second display has a higher resolution relative to the first display) or zoomed out view (e.g. if the second display has a lower resolution relative to the first display) of the portion (e.g. particular content within the portion identified as being looked at by the user).

Still in reference to FIG. 3, after block 308 the logic moves to block 310, at which the logic identifies a second scaling factor for presenting content (e.g. the element) on the second display based on one or more differences in display characteristics between the first display and the second display. For instance, the second scaling factor may be based on the difference in dot pitch between the first and second displays, the difference in dots per inch and/or pixels per inch between the first and second displays, the difference in display resolutions as respectively indicated by the first and second displays to the present device, and/or the difference in the respective heights and widths of the first and second displays as respectively indicated by the first and second displays to the present device. After block 308 the logic then moves to block 312.

At block 312 the logic, in response to determining that a threshold amount of the element has been moved to the second display e.g. based on eye input and/or a drag and drop action, scales the at last threshold amount of the element presented on the second display using the second scaling factor and presents the at least threshold amount of the element on the second display using the second scaling factor at at least substantially the same height and/or width as the at least threshold amount of the element was presented on the first display. Note that the threshold amount may in sonic embodiments be the entire element such that e.g. responsive to the element being entirely moved from the first display to the second display with no portion of the element being still presented on the first display, the element may be scaled and presented on the second display using the second scaling factor at the same height and width as the element was entirely presented on the first display.

Also note that substantially the same height and/or width as referenced above may in some embodiments be e.g. at the exact height and width, but at least e.g. the height and width within a margin of error of two pixels, five pixels, one dot pitch, three dot pitches, etc. No withstanding those examples, note that the margin of error may vary based on display resolution for a display to which an element is moved. E.g., the margin of error may be based on the proportion of dots per inch (DPI) or a particular display relative to another display from which the element was moved to thus scale based on what the user could see. Accordingly, e.g. for a relatively low DPI (fewer dots per inch) a relatively lower pixel count for the margin of error may be used, but for a relatively high DPI (more dots per inch) to relatively higher pixel count for the margin of error may be used.

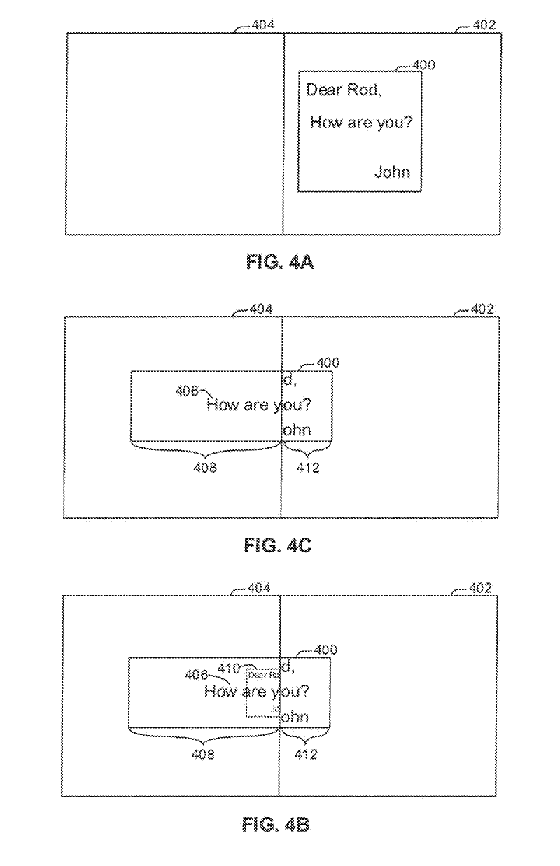

Now in cross-reference to FIGS. 4A-4C, these three figures show an example email user interface (UI) 400 (presenting at least a particular email) which may be moved from a first display 402 to a second display 404 in accordance with present principles. Note that the displays 402 and 404 as shown in these example drawings are arranged side by side and are of the same height and width, though it is to be understood that they may be of differing heights and/or widths in some embodiments. Also note that in the present example, the display 402 is understood to have a relatively lower resolution that the display 404.

As shown in FIG. 4A, the UI 400 is presented entirely on the first display 402. As shown in FIG. 4B, a portion 406 of a lateral segment 408 is presented on the second display 404 which was determined to be looked at by the user e.g. within a threshold time of at least some of the segment 408 comprising the portion 406 being moved to the second display 404 for presentation thereon. Note that only the text “How are y” is presented on the second display 404 while other portions of the lateral segment 408 that would otherwise comprise the text “Dear Ro” and “Jo” are not presented on either of the first display 402 and second display 404 owing to those text sequences being otherwise presented on the lateral segment 408 moved to the second display 404 save for the device controlling the first and second displays 402 and 404 (referred to below as the “present device” for simplicity) determining using data from one or more cameras that the user was looking at the portion 406 of the lateral segment 408 comprising the text “How are y” but not the text “Dear Ro” and “Jo” while moving the segment 408, and thus that the text “How are y” is to be presented on the second display 404 but not the text “Dear Ro” and “Jo” while the element 400 is being moved from the first display 402 to the second display 404.

Still in reference to FIG. 413, also note that the text “How are y” presented on the display 404 has been zoomed in on while the element 400 is still presented using a first scaling factor (for the display 402) on both of the displays 402 and 404 since the display 404 has a relatively higher resolution than the display 402 and would therefore otherwise present text smaller using the same scaling factor than the text would be presented on the display 402. Furthermore, note that the segment 408 as shown in FIG. 4B is presented at the same height as the entirety of the element 400 as shown in FIG. 4A as defined by upper and lower bounds (e.g. upper and lower sides of the element 400 and is presented next to another lateral segment 412 so that the UI 400 still looks as unified as possible despite being, presented on two different displays. Thus, relative to the user, and while the user is moving the element 400 between displays, at least the portion 406 being looked at still looks mostly the same as it aid when presented on the display 402. Notwithstanding, it is to be understood that in some embodiments no zooming may be performed, and hence FIG. 4C shows an example of an embodiment where only the portion 406 of the lateral segment 408 is presented on the second display 404 without zooming in on the portion 406 while the element 400 is being moved. Accordingly, it is to be understood that whether to zoom in (or zoom out in other embodiments) while moving an element from one display to another in accordance with present principles may be based on e.g. user input such as e.g. providing input to a settings user interface for configuring settings of one or more applications undertaking present principles. But in either ease (whether to zoom in or out, or not do so), and also in example embodiments, only the portion 406 being looked at is presented.

Referring again to FIG. 4B, for illustration as shown but with the understanding that it is not actually presented on the display 404, note that the text “Dear Ro” and “Jo” is shown by perforations 410 to demonstrate what those portions of the lateral segment 408 would look like upon movement to the display 404 using the first scaling factor mentioned in the preceding paragraph and without zooming in on those portions owing to the display 404 having a relatively higher resolution that the display 402.

Before moving on in the detailed description to other figures, also note that once the element 400 has been moved entirely to the second display 404, the element 400 may be presented on the display 404 at a location indicated by a user using a second scaling factor that is based on the difference in display resolution between the first display 402 and second display 404 such that the element 400 is presented on the display 404 at at least substantially the same height and width as it was presented on the display 402 (e.g. as shown in FIG. 4A but presented on the display 404 instead).

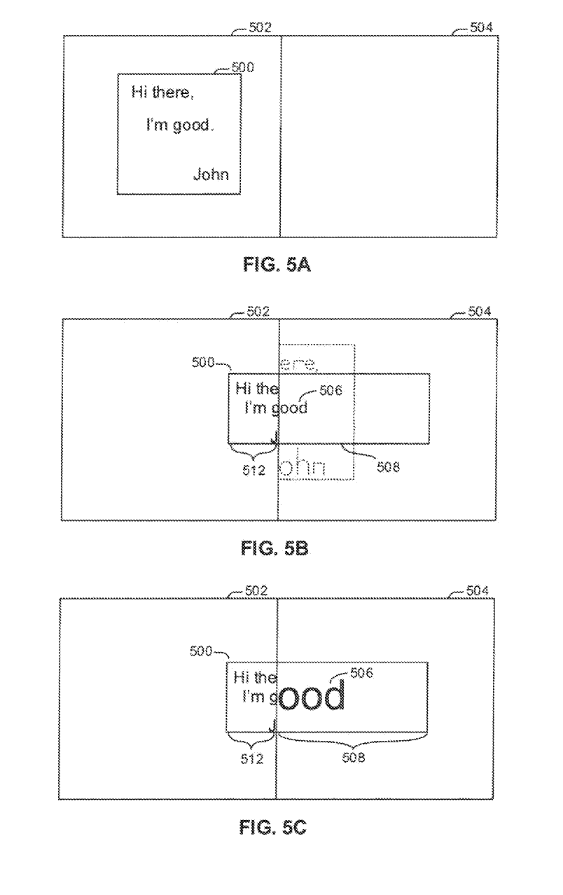

Now in cross-reference to FIGS. 5A-5C these three figures show an example email user interface (UI) 500 which may be moved from a display 502 to a display 504 in accordance with present principles. Note that the displays 502 and 504 as shown in these example drawings are arranged side by side and are of the same height and width, though it is to be understood that they may be of differing heights and/or widths in some embodiments. Also note that in the present example, the display 502 is understood to have a relatively higher resolution that the display 504.

As shown in FIG. 5A, the UI 500 is presented entirely on the display 502. As shown in FIG. 5B, a portion 506 of a lateral segment 508 is presented on the display 504 which was determined to be looked at by the user e.g. within a threshold time of at least some of the segment 508 comprising the portion 506 be moved to the display 504 for presentation thereon. Note that only the text “ood” is presented an the display 504 while other portions of the lateral segment 508 that would otherwise comprise the text “ere” and “ohn” are not presented on either of the display 502 and display 504 owing to those text sequences being otherwise presented on the lateral segment 508 moved to the display 504 save for the device controlling the displays 502 and 504 determining using data from one or more cameras that the user was looking at the portion 506 of the lateral segment 508 comprising the text “ood” but not the text “ere” and “ohn” while moving the segment 508, and thus that the text “ood” is to be presented on the display 504 but not the text “ere” and “ohn” while the element 500 is being moved from the display 502 to the display 504.

Still in reference to FIG. 5B, also note that the text “ood” as presented on the display 504 has been zoomed out on while the element 500 is still presented using a first scaling factor (for the display 502) on both of the displays 502 and 504 since the display 504 has a relatively lower resolution than the display 502 and would therefore otherwise present text bigger using the same scaling factor than the text would be presented on the display 502. Furthermore, note that the segment 508 as shown in FIG. 5B is presented at the same height as the entirety of the element 500 as shown in FIG. 5A as defined by upper and lower bounds (e.g. upper and lower sides) of the clement 500 and is presented next to another lateral segment 512 so that the UI 500 still looks as unified as possible despite being presented on two different displays. Thus, relative to the user, and while the user is moving the element 500 between displays, at least the portion 506 being looked at still looks mostly the same as it did when presented on the display 502. Notwithstanding, it is to be understood that in some embodiments no zooming may be performed, and hence FIG. 5C shows an example of an embodiment where only the portion 506 of the lateral segment 508 is presented on the second display 404 without zooming out on the portion 506 while the element 500 is being moved.

Referring again to FIG. 5B, for illustration as shown but with the understanding that it is not actually presented on the display 504, note that the text “ere” and “ohn” is shown by perforations 510 to demonstrate what those portions of the lateral segment 508 would look like upon movement to the display 504 using the scaling factor for the display 502 and without zooming out on those portions owing to the display 504 having a relatively lower resolution that the display 502.

Before moving on in the detailed description, also note that once the element 500 has been moved entirely to the display 504, the element 500 may be presented on the display 504 at a location indicated by a user using a scaling factor that is based on the difference in display resolution between the display 502 and display 504 such that the element 500 is presented on the display 504 at at least substantially the same height and width as it was presented on the display 502 (e.g. as shown in FIG. 5A but presented on the display 504 instead).

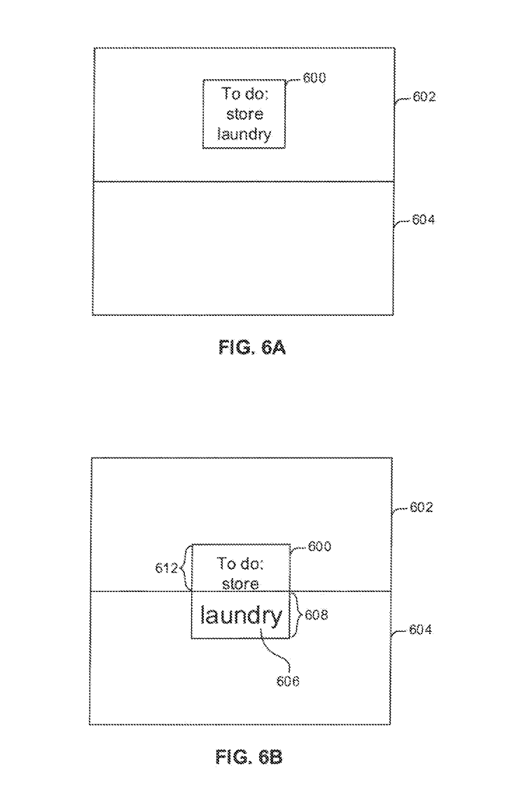

Now in cross-reference to FIGS. 6A and 6B, these figures show an example note taking application user interface (UI) 600 which may be moved hum a display 602 to a display 604 in accordance with present principles. Note that the display 602 as shown in these example drawings is arranged on top of the display 604, and that the displays 602 and 604 are of the same height and width even though it is to be understood that they may be of differing heights and/or widths in some embodiments. Also note that in the present example, the display 602 is understood to have a relatively lower resolution that the display 604.

As shown in FIG. 6A, the UI 600 is presented entirely on the display 602. As shown in FIG. 6B, a portion 606 of a vertical segment 608 is presented on the display 604 which was determined to be looked at by the user e.g. within a threshold time of at least some of the segment 608 comprising the portion 606 being moved to the display 604 for presentation thereon. Note that the portion 606 as shown which comprises the text “laundry” is understood to be zoomed in on while the element 600 is still presented using first scaling factor (for the display 602) on both of the displays 602 and 604 since the display 604 has a relatively higher resolution than the display 602 and would therefore otherwise present text smaller using the same scaling factor than the text would be presented on the display 602. Furthermore, note that the segment 608 as shown in FIG. 643 is presented at the same width as the entirety of the element 600 as shown in FIG. 6A as defined by left and right bounds (e.g. left and right sides) of the element 600 and is presented below to another vertical segment 512 so that the UI 600 still looks as unified as possible despite being presented on two different displays. Thus, relative to the user, and while the user is moving the element 600 between displays, at least the portion 606 being looked at still looks mostly the same as it did when presented on the display 602.

Furthermore, though not shown, note that once the element 600 has been moved entirely to the display 604, the element 600 may be presented on the display 604 at a location indicated by a user using a scaling factor that is based on the difference in display resolution between the display 602 and display 604 such that the element 600 is presented on the display 604 at at least substantially the same height and width as it was presented on the display 602 (e.g. as shown in FIG. 6A but presented on the display 604 instead).

Without reference to any particular figure, it may now be appreciated that e.g. a scaling factor determined based on the difference in display characteristics between two displays may be one of a higher percentage of dots per inch (DPI) of a first display relative to a second display, or a lower percentage DPI of the first display relative to the second display. Furthermore, note that present principles may be undertaken even when the displays are not juxtaposed side by side and/or top to bottom but also e.g. when spaced apart and/or when arranged along a diagonal relative to each other. What's more, in some embodiments, such as e.g. a side-by-side display embodiment, a camera may be respectively mounted on the top of each of the displays (e.g. clamped thereto, and/or integrated into the display chassis) to track a user's eye movement.

Accordingly and also without reference to any particular figure, it is to be understood that in some embodiments, determining whether the user is looking at least substantially at portion of an element may include e.g. determining whether the user is looking around and/or toward the element (e.g. within a threshold distance) based on images from the cameras which communicate with the device executing eye tracking software and applying the eye tracking software to the images, determining whether the user is looking directly at the portion of the element based on images from the cameras and applying the eye tracking software to the images, and/or determining whether the user is looking within a threshold number of degrees of looking at the portion of the element based on vectors e.g. established by the user's actual line of sight toward a location on the display on which the portion is presented and established based on the actual location of presentation of the portion on the display relative to at least one of the users eyes (e.g. using images from the cameras and applying the eye tracking software to the images).

Still without reference to any particular figure n is to be understood that in some embodiments after the device adjusts presentation of an element on a display to a scaling factor based on the difference in display characteristics between two displays as described herein, should a user wish to adjust this scaling factor further based on his or her own preference, the user may do so (by dragging a corner of the element to expand it), which may cause a device undertaking present principles to thereafter save this user preference and when determining future scaling factors based on display differences account for this user adjustment and scale according to both user preference and display characteristic differences. Thus, e.g. should the scaling factor be determined to be two hundred percent based on a difference in DPI alone, and then the user adjusts another five percent to render a user-adjusted sealing factor of two hundred five percent future scaling factors for that particular display may be increased two and a half percent beyond the DPI difference based on the user adjusting the two hundred percent scaling factor up another two and a half percent of the two hundred percent to a resulting two hundred five percent.

Furthermore, it is to be understood that in some embodiments, when e.g. moving a portion of an element to a display in accordance with present principles fir a first time for a particular display, a user may be presented on that display with a prompt and/or user interface prompting a user to adjust the scale for the element so that the identified scaling factor and/or future scaling factor's that are determined for that display can be adjusted accordingly (e.g. according to user preference in addition to display difference characteristics). For example, a user may be presented with a user interface not only including the prompt described in the preceding sentence but also providing a number entry area at which a user may enter a number corresponding to a percent the user wishes that the element be scaled up or down from its presentation using the identified sealing factor.

Still further, it is to be understood that when a display provides to a system controlling the display information about its characteristics (e.g. dot pitch), such information may be provided as e.g. extended display identification (EDI) data. What's more, once e.g. EDI data for a particular display is determined, and another display is used as a target location at which to present a portion of an element in accordance with present principles but for which EDI data is unavailable a system undertaking present principles may determine an appropriate scaling factor by accessing EDI data for a different display of the same display class and determining a scaling factor based on the different display of the same class while e.g. also accounting for display characteristics that, although not provided by the display on which the element is to be presented, can nonetheless be identified.

Regarding the zooming in or zooming out on a portion of an element as described herein, the zoom in out nay be e.g. a predetermined amount configured by a user, based on what the device determines would be readable as text, based on the size of the same respective text as presented on the other of the two displays, etc.

Providing an example in accordance with present principles, a device may e.g. query a first display on which an element is presented and determine that it is e.g. a 3 K resolution display. The device may also determine that the user has scaled the element to be presented on the 3 K display at two hundred percent. When the user then moves a portion of the element to another display with half the resolution of the 3 K display, the device may “guess” that a one hundred percent scaling factor may be appropriate owing to the other display having half the resolution of the 3 K display. Furthermore, in some embodiments after doing so, the device may also determine whether text presented in the portion is readable to a human eye (e.g. too small to read, and/or too big to fit entirely on the display) and further adjust the scaling factor for the portion until it is readable.

Notwithstanding, it is to be understood that present principles apply not just to scaling portions of elements comprising text but also sealing other portions of elements (e.g. UIs) such as graphics.

It may now be appreciated that present principles provide for a scaling solution for each monitor of a plural monitor configuration. A scaling factor for each monitor can be automatically calculated based on e.g. dot pitch, resolution, and/or through a query process with the end user. Optionally, the user may override settings to further fine tune the presentation of an element that has been moved from a different monitor. The scaling factor may be scaling up or down depending on the resolution of the monitor from which the element is being moved (e.g. a “main” monitor). Thus, for example, if a main laptop monitor is a 2.5 K display (where a 200% scale for fonts is applicable using a 72 points per inch standard for a user's desired that height of 12 points) and the user moves to a full HD monitor, the user may configure an adjustment scale of 50%, which would be applied to the 200% sealing factor, and thus yield a 100% font scale for the full HD monitor to have the fonts and images look “correct” (e.g. similar to as they looked on the main laptop monitor). As another example, if a user has a lower resolution laptop display and wishes to move an element to a 4 K external monitor, the scaling factor that results may be based on applying 115% on top of the users preset 100% to thus yielding a 215% sealing factor for the 4 K external monitor.

Before concluding, it is to be understood that although e.g. a software application for undertaking present principles may be vended with a device such as the system 100, present principles apply in instances where such an application is e.g. downloaded from a server to a device over a network such as the Internet. Furthermore, present principles apply in instances where e.g. such an application is included on a computer readable storage medium that is being vended and/or provided, where the computer readable storage medium is not a carrier wave and/or a signal per se.

While the particular MOVEMENT OF DISPLAYED ELEMENT FROM ONE DISPLAY TO ANOTHER is herein shown and described in detail, it is to be understood that the subject matter which is encompassed by the present application is limited only by the claims.

What is claimed is:

1. A device, comprising:
a processor;
a first display accessible to the processor; and
a memory accessible to the processor and hearing instructions executable by the processor to:
in response to movement to the first display of a lateral segment of an element presented on a second display, present a portion of the lateral segment on the first display at a first scaling factor and at the same height as the entirety of the lateral segment was presented on the second display;
identify a second scaling factor based on a difference in display characteristics between the first display and the second display; and
in response to movement of at least a threshold amount of the element onto the first display, present at least the threshold amount of the element on the first display using the second scaling factor.

2. The device of claim 1, wherein the lateral segment is defined at least in part by a upper and lower bounds, and wherein in response to the movement to the first display of the lateral segment of the element, the instructions are executable to present only the portion.

3. The device of claim 2, wherein the portion does not comprise the entirety of the lateral segment between the upper and lower bounds, and wherein in response to the movement to the first display of the lateral segment of the element, the instructions are executable to present only the portion and no additional portions of the lateral segment within the upper and lower bounds outside the portion.

4. The device of claim 1, wherein the first seating factor is provided by a host operating system executing on the device.

5. The device of claim 4, wherein the first scaling factor is a default scaling factor not accounting for a difference in resolution between the first display and the second display.

6. The device of claim 1, wherein the second scaling factor is based at least in part on a factor selected from the group consisting of the difference in dot pitch between the first display and the second display, the difference in dots per inch between the first display and the second display, both the respective display resolutions of the first display and second display as respectively indicated by the first display and second display and the respective heights and widths of the first display and the second display as respectively indicated by the first display and the second display.

7. The device of claim 6, wherein the second scaling factor is based on the difference in dots per inch (DPI) between the first display and the second display, and wherein the second scaling factor is selected from the group consisting of a higher percentage of DPI of the first display relative to the second display, a lower percentage DPI of the first display relative to the second display.

8. The device of claim 1, wherein the instructions are executable to:
in response to movement of the element entirely onto the first display, present the element on the first display using the second sealing factor to present the element on the first display at at least substantially the some height and width that the element was presented in its entirety on the second display.

9. The device of claim 8, wherein substantially the same height and width is the same height and width that the element was presented in its entirety on the second display to within five pixels.

10. The device of claim 8, wherein substantially the same height and with is the same height and width that the clement was presented in its entirety on the second display to within three dot pitches.

11. The device of claim 8, wherein substantially the same height and width is the same height and width.

12. The device of claim 1, wherein the portion is identified based at least in part on identification of a user as looking at the portion.

13. The device of claim 1, wherein the element is a window associated with an application that is being executed.

14. The device of claim 1, wherein the first display is a different display device than the second display.

The device of claim 1, wherein the threshold amount is more than fifty percent of the width of the element as presented entirely on the second display.

16. A method, comprising:
in response to movement to a first display of at least one of a lateral segment of a window presented on a second display and a vertical segment of the window presented on the second display, presenting at least one respective portion of at least one of the intend segment and the vertical segment on the first display at at least one of a first height matching a second height at which the entirety of the lateral segment was presented on the second display and a first width matching a second width at which the entirety of the vertical segment was presented on the second display;
identifying a scaling factor based on a difference in pixels per inch (PPI) between the first display and the second display; and
in response to movement of the window entirely onto the first display, presenting the window on the first display using the scaling factor.

17. The method of claim 16, wherein the portion is identified in response to identifying a user as looking at the portion as presented on the second display within a threshold time of movement to the first display of at least one of the lateral segment and the vertical segment.

18. The method of claim 17, wherein the portion is identified in response to identifying the user as looking at the portion as presented on the second display within the threshold time of movement to the first display of at least one of the lateral segment and the vertical segment, and identifying the user as not looking at another portion of the element prior to movement to the first display of at least one of the lateral segment and the vertical segment.

19. The method of claim 17, wherein portion is identified in response to identifying user as looking at the portion as presented on the second display within the threshold time of movement to the first display of at least one of the lateral segment and the vertical segment and then looking at the first display.

20. A computer readable storage medium that is not a carrier wave, the computer readable storage medium comprising instructions executable by a processor to:
identify a user looking at a portion of a user interface (UI) presented on a first display;
identify movement of the UI at least partially from the first display to a second display;
present, on the second display, the portion of the UI looked at by the user while the UI is moved from the first display to the second display;
identify a scaling factor at which to present the UI on the second display; and
in response to movement of the UI entirely to the second display, present the UI entirely on the second display using the scaling factor.
